(19) United States
(12) Patent Application Publication
(10) Pub. No.: US 2006/0202150 A1
(43) Pub. Date: Sep. 14, 2006

(54) Valve assembly with angled valve guide

(75) Inventor: Jerry E. Johnson, Houston, TX (US)

Correspondence Address: CONLEY ROSE, P.C., P. O. BOX 3267, HOUSTON, TX, 77253-3267, US

(73) Assignee: National-Oilwell, L.P., Houston, TX (US)

(21) Appl. No.: 11/372,500

(22) Filed: Mar. 10, 2006

Related U.S. Application Data
(60) Provisional application No. 60/661,581, filed on Mar. 14, 2005.

(51) Int. Cl. F16K 27/02

(52) U.S. Cl. 251/336

(57) ABSTRACT

A valve assembly is disclosed comprising a valve member with an elastomeric upper stem guide and a lower valve guide comprising lateral support members including an angled surface. During operation, fluid impacting the angled surface imparts a rotational force on the lower valve guide and valve member. Consequently, the valve member strikes a sealing member in different rotational positions during repetitive cycling of the valve assembly.

### CROSS-REFERENCE TO RELATED APPLICATIONS

The present application claims priority to U.S. Provisional Application No. 60/661,581, filed Mar. 14, 2005, and titled “Leg Guide Valve Assembly,” which is hereby incorporated by reference herein for all purposes.

### STATEMENT REGARDING FEDERALLY SPONSORED RESEARCH OR DEVELOPMENT

Not Applicable.

### BACKGROUND INFORMATION

The present invention relates generally to methods and apparatus for controlling flow in a pump. More particularly, the present invention relates to suction and discharge valves for reciprocating pumps used to pump fluids.

Suction and discharge valves are used in reciprocating pumps to control the flow of fluid into and out of the cylinders in which the fluid is pressurized. Reciprocating pumps are used in various operations to pressurize an often abrasive slurry mixture of solids and liquids. For example, reciprocating pumps are used in drilling operations to pressurize a slurry mixture of solids and liquids known as drilling mud to the bottom of a hole drilled into the earth. The pressurized mud is used to lubricate and cool a downhole drill bit as well as to carry loosened sediment and rock cuttings back to the surface. At the surface, the larger cuttings and much of the sediment are removed from the returning drilling mud enabling the filtered drilling mud to be reused. Nevertheless, highly abrasive particles are present in the fluids that are being pumped through the system.

Because of these highly abrasive components, valves and seals of reciprocating pumps must be designed to resist harsh abrasion, while maintaining positive sealing action and withstanding high operating pressures. Due to the abrasive and corrosive nature of most drilling fluids, these valves have a finite service life and must be replaced when the leakage rate increases to a point that the pump will not maintain satisfactory pressure for the drilling conditions. These valves and seats normally fail due to a deterioration of the elastomer sealing element of the valve, erosion cause by fluid cutting of the valve and seat metal contact surfaces, or a combination of these two. Because the maintenance of these valves is a time consuming and expensive process, valves having an increased service life are desirable.

Thus, there remains a need to develop methods and apparatus for suction and discharge valves that overcome some of the foregoing difficulties while providing more advantageous overall results.

### SUMMARY OF THE PREFERRED EMBODIMENTS

The embodiments described herein are directed toward methods and apparatus for increasing the service life of a valve assembly. More specifically, the described embodiments comprise valve guides with canted or angled lateral support members which allow fluid flow to impart a rotational force on the valve member (i.e., the closure member) of the valve assembly. Consequently, the valve member strikes a seating member in different rotational positions during repetitive cycling of the valve assembly. Certain embodiments also comprise an elastomeric upper stem guide that compensates for misalignment and reduces friction between components.

The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of the preferred embodiment of the present invention, reference will now be made to the accompanying drawings, wherein:

FIG. 1 is a partial sectional view showing a pump assembly;

FIG. 2 is a cross-sectional elevation view of a valve assembly suitable for use in the pump assembly of FIG. 1;

FIG. 3 is a partial section view of a valve guide as may be employed in the valve assembly of FIG. 2;

FIG. 4 is a top view of a valve guide as may be employed in the valve assembly of FIG. 2; and

FIG. 5 is a cross-sectional view of a valve member as may be employed in the valve assembly of FIG. 2.

### DETAILED DESCRIPTION OF THE PREFERRED EMBODIMENTS

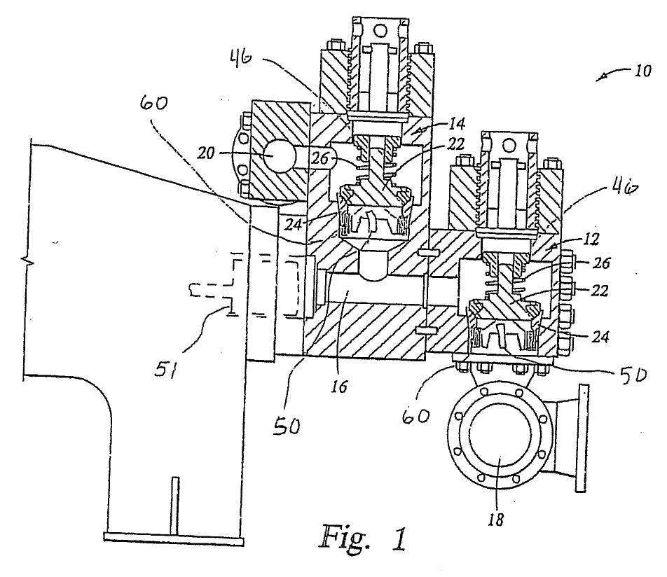

Referring now to FIG. 1, pump fluid-end assembly 10 comprises suction valve assembly 12 and discharge valve 14 assembly that are actuated by a piston and cylinder assembly 51 via conduit 16. Suction valve assembly 12 is connected to fluid inlet or supply 18 and allows fluid to flow into conduit 16. Discharge valve assembly 14 is connected to fluid discharge or outlet 20 and allows fluid to flow out of conduit 16. Each valve assembly 12, 14 comprises a valve member 22 that is urged into sealing engagement with a seating member 24 by a biasing member 26. Each valve assembly 12, 14 also comprises an upper stem bushing 46, and a lower valve guide 50 which engages a seat bore 60 of seating member 24. Valve assemblies 12 and 14 are opened by pressure acting on valve member 22 so as to compress biasing member 26 and move valve member 22 out of engagement with seating member 24. Thus, each valve assembly 12 and 14 only allows flow in one direction through the valve. The valve assemblies are arranged such that suction valve assembly 12 allows fluid to flow into conduit 16 and discharge valve assembly 14 allows fluid to flow out of conduit 16.

As the piston moves rearward and increases the volume within its cylinder, discharge valve 14 closes and suction valve 12 opens so that fluid flows from fluid supply 18 into conduit 16. The piston then reverses, thus increasing the pressure within conduit 16 so that suction valve 12 closes and discharge valve 14 opens so as to allow fluid to flow into fluid outlet 20. The cycle repeats, often at a high cyclic rate, as fluid is being pumped.

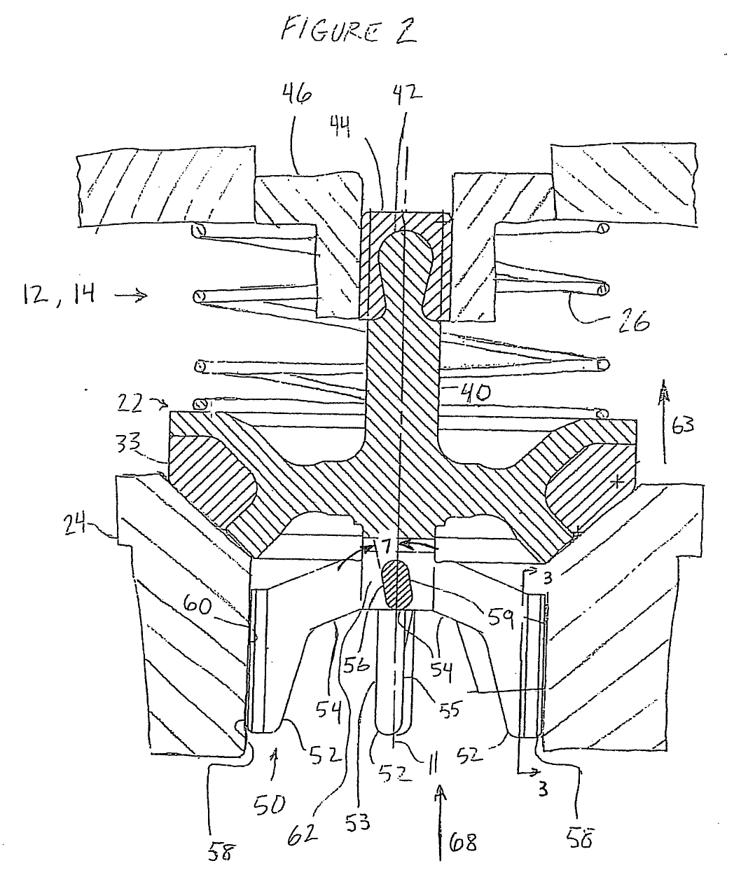

Referring now to FIGS. 2-4, valve assembly 12, 14 is shown with a more detailed view of valve member 22 and lower valve guide 50. As shown in FIG. 2, valve assembly 12, 14 comprises valve member 22, biasing member 26, seating member 24 and lower valve guide 50. Valve member 22 further comprises insert 33, upper stem 40, and upper stem guide 44. A longitudinal axis 11 extends through valve member 22 and lower valve guide 50.

Upper stem 40 further comprises engaging surface 42, while lower valve guide 50 further comprises center member 62 and a plurality of legs 52 with a plurality of lateral support members 54 extending therebetween. Lateral support member 54 further comprises a pair of sides with a pair of angled surfaces 56 and 59. In other embodiments, only one side of lateral support member may be angled.

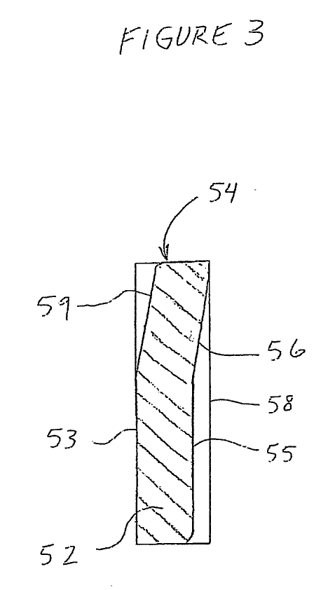

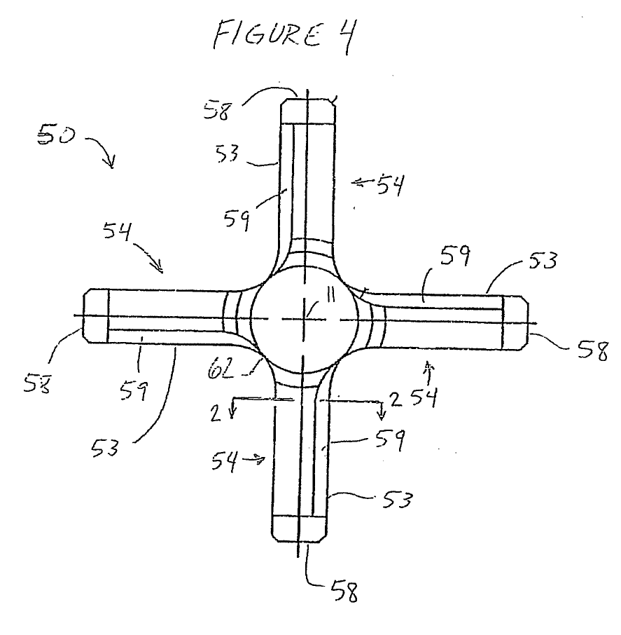

As shown in FIGS. 2-3, leg 52 further comprises a pair of side surfaces 53 and 55 and an outer surface 58. Upper stem guide 44 engages upper stem bushing 46 while lower valve guide 50 engages seat bore 60. A cross section represented by the line A-A of FIG. 2 is shown in the section view of FIG. 3. In FIG. 2, valve member 22 is shown in section view through its center, while lateral support member 44 is shown in section view taken at the line 2-2 in FIG. 4.

Referring now to FIG. 3, a section view of lateral support member 54 and valve guide leg (or outer member) 52 is shown. Valve guide leg 52 comprises side surfaces 53 and 55, while lateral support member 54 comprises a pair of sides with angled surfaces 56 and 59. As shown in FIG. 3, angled surface 56 is oriented at an angle from side surface 55 and angled surface 59 is oriented at an angle from side surface 53. A top view of lower valve guide 50 is shown in FIG. 4. As shown, lower valve guide 50 comprises a central or center member 62 from which valve guide wings or lateral support members 54 extend to outer surfaces 58. Longitudinal axis 11 extends through the center of center member 62. In the embodiment shown in FIG. 4, angled surfaces 59 are shown on one side of valve guide lateral support members 54. Also visible is side surface 53 of lateral support member 54.

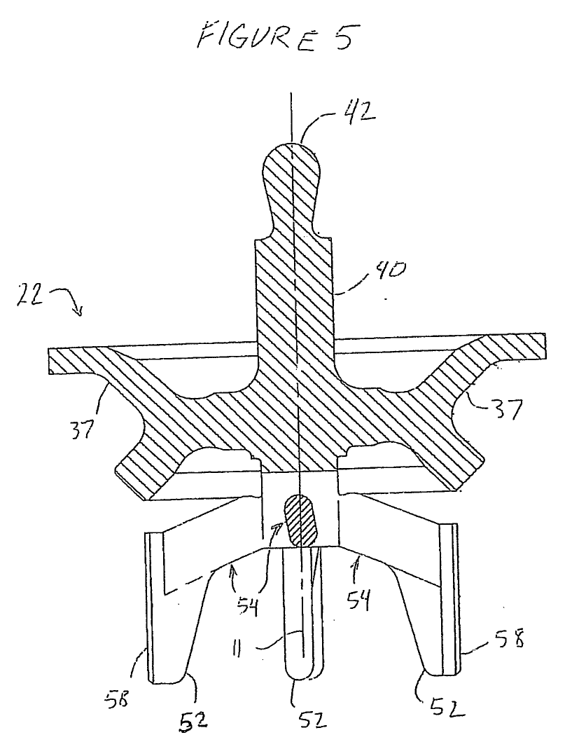

Referring now to FIG. 5, valve member 22 is shown before upper stem guide 44 and insert 33 have been bonded or attached to valve member 22. Again, valve member 22 is shown in section view through its center, while lateral support member 44 is shown in section view taken at the line 2-2 in FIG. 4. In preferred embodiments, upper stem guide 44 and insert 33 (see FIG. 2) are comprised of an elastomeric material, such as polyurethane, and are molded into place on valve member 22. While one configuration of engaging surface is shown in the embodiment of FIG. 5, different configurations may be used in other embodiments of the invention.

Referring back now to FIG. 2, the embodiment shown comprises features which are intended to increase the service life of the components in normal operation. For example, upper stem guide 44 in this embodiment is comprised of an elastomeric material such as polyurethane, which has a lower coefficient of friction than the metal components typically found on many prior art devices. This elastomeric material therefore reduces the friction between upper stem 40 and upper stem bushing 46. The reduced friction decreases wear on upper stem bushing 46 and upper stem guide 44 and increases the ability of upper stem 40 to accommodate misalignment between upper stem bushing 44 and bore 60 of seating member 24, as explained below.

After a pump has been in service for an extended period of time, it is common for wear on different components to cause upper stem bushing 44 and seating member 24 to move relative to each other so that upper stem bushing 44 and bore 60 of seating member 24 are no longer concentric. This creates misalignment between upper stem bushing 44 and bore 60 of seating member 24 and leads to increased stress on upper stem 40 as the valve actuates and upper stem guide 44 moves relative to upper stem busing 46 and end surface 58 of lower valve guide 50 engages bore 60 of seating member 24. Because the valve assembly 12, 14 actuates at a high cyclic rate, any stress placed on upper stem 40 may detrimentally affect structural integrity, such as by causing cracking due to fatigue or other failure mechanisms that could lead to a fracture of upper stem 40.

As previously mentioned, the elastomeric material of upper stem guide 44 reduces the friction created between upper stem 40 and upper stem bushing 46. In addition to decreasing wear, the reduction in friction also lowers the stress placed on upper stem 40 when the valve actuates while upper stem bushing 46 and bore 60 of seating member 24 are not concentrically aligned. This reduction in stress placed on upper stem 40 makes it less likely that upper stem 40 will be fractured during actuation of valve assembly 12, 14. The addition of elastomeric upper stem guide 44 therefore increases the service life of valve member 22 by reducing the wear of upper stem bushing 46 and upper stem guide 44, as well as reducing the likelihood that upper stem 40 will suffer from a fracture.

The embodiment shown in FIGS. 2 and 3 also comprise canted or angled valve guide wings or lateral support members 54. As shown in FIGS. 2-3, angled surface 56 is oriented at an angle relative to axis 11 and side surface 55 of valve guide leg 52. Also shown in FIGS. 2-3, angled surface 59 is oriented at an angle relative to axis 11 and side surface 53 of valve guide leg 52.

As shown in FIG. 2, angled surfaces 56 and 59 are angled at an angle 7 relative to axis 11. While the embodiment of FIGS. 2 and 3 shows an angle of approximately eleven degrees between angled surfaces 56 and 59 and side surfaces 55 and 53, other embodiments can comprise different angles. Referring now to FIGS. 2 and 3, as the valve opens and valve member 22 moves up, in the direction of arrow 63 shown in FIG. 2, fluid (not shown) will flow between seating member 24 and insert 33. This will cause fluid to flow past valve guide lateral support member 54. A component of the fluid flow will be in the direction of arrow 68 shown in FIG. 2 and generally parallel to axis 11 and side surfaces 53 and 55 of valve guide legs 52 until the fluid impacts angled surface 56. When fluid impacts angled surface 56, it will impart a rotational force on lower valve guide 50, causing lower valve guide 50 to rotate slightly each time the valve is opened. In certain embodiments, valve member 22 is designed to rotate approximately 1/32 to 1/16 of an inch each time valve member 22 opens. In general, as angle 7 is increased, the amount that valve member 22 rotates during each opening will also increase. However, if angle 7 becomes too severe, increased wear may occur on insert 33.

Lower valve guide 50 is coupled to valve member 22, and therefore valve member 22 will also rotate with lower valve guide 50. The decreased friction resulting from the use of elastomeric upper stem guide 44 also makes it easier for valve member 22 to rotate. This permits insert 33 to strike seating member 24 in different rotational positions during repetitive cycling of valve member 22. As compared to certain conventional devices where the valve repeatedly strikes a seating member at the same location, the construction of valve member 22 will create more uniform wear on insert 33 and seating member 24 and is intended to reduce the likelihood that a solid particle in the fluid will create a failure point or leak path between insert 33 and seating member 24. This rotation of valve member 22 offers the potential to increase the service life of the valve and lead to reduced equipment downtime and maintenance costs as compared to prior art devices.

While preferred embodiments have been shown and described, modifications thereof can be made by one skilled in the art without departing from the scope or teaching of this invention. The embodiments described herein are exemplary only and are not limiting. Many variations and modifications of the system and apparatus are possible and are within the scope of the claimed invention. For example, the relative dimensions of various parts, the materials from which the various parts are made, and other parameters can be varied. In addition, use of the term “between” when describing the location of a component should not be construed such that the component must be directly contacting the adjacent members. Furthermore, in other embodiments the valve guide may comprise an outer surface that is a circular ring rather than individual end portions. Accordingly, the scope of protection is not limited to the embodiments described herein, but is only limited by the claims that follow, the scope of which shall include all equivalents of the subject matter of the claims.

What is claimed is:

1. A valve guide for a valve assembly comprising:
a center member with a longitudinal axis;
an outer member; and
a lateral support member extending between the center member and the outer member, wherein the lateral support member comprises a first side surface that is angled relative to the longitudinal axis.

2. The valve guide of claim 1 wherein the first side surface of the lateral support member is angled relative to the longitudinal axis at an angle between approximately nine and thirteen degrees.

3. The valve guide of claim 1 wherein the valve guide is configured so that a fluid flow in a direction generally parallel with the longitudinal axis will impart a rotational force on the valve guide.

4. The valve guide of claim 1 wherein the outer member comprises a leg with an end surface and a pair of leg side surfaces and the first side surface of the lateral support member is angled relative to a leg side surface.

5. The valve guide of claim 4 wherein the first side surface of the lateral support member is angled relative to the leg side surface at an angle of approximately nine to thirteen degrees.

6. A valve assembly comprising:
a valve member comprising a stem;
a valve guide coupled to the valve member, the valve guide comprising:
a center member;
an outer member; and
a lateral support member extending between the center member and the outer member;
a seating member comprising a bore, wherein the valve guide is disposed within the bore;
a biasing member biasing the valve member towards the seating member; and
a longitudinal axis extending through the stem, the center member and the bore, wherein the lateral support member comprises a side surface that is angled relative to the longitudinal axis.

7. The valve assembly of claim 6 wherein the side surface of the lateral support member is angled relative to the longitudinal axis at an angle between approximately nine and thirteen degrees.

8. The valve assembly of claim 6 wherein the valve member further comprises an insert bonded to the stem, the insert being distal from the valve guide.

9. The valve assembly of claim 8 wherein the insert is comprised of an elastomeric material.

10. The valve assembly of claim 8 wherein the insert is disposed within a stem bushing.

11. The valve assembly of claim 6 wherein the side surface is configured so that a fluid flow through the bore will impart a force on the side surface and cause the valve guide to rotate about the longitudinal axis.

12. The valve assembly of claim 11 wherein the fluid flow biases the valve member in a direction away from the seating member such that the valve member cyclically engages and disengages the seating member and the valve member engages the seating member in a plurality of different rotational positions.

13. A valve member for a valve assembly comprising:
a disc-shaped portion with a first insert coupled to an outer circumference of the disc-shaped portion;
a stem extending from the disc-shaped portion, wherein the stem has an engaging surface formed at an end of the stem distal from the disc-shaped portion; and
a second insert bonded or coupled to the engaging surface.

14. The valve member of claim 13 wherein the first insert is an elastomeric material.

15. The valve member of claim 13 wherein the second insert is an elastomeric material.

16. The valve member of claim 13 wherein:
the engaging surface comprises a base portion and an upper portion;
the base portion is proximal to the stem; and
the base portion has a smaller cross-sectional area than the upper portion.
